(19) United States
(12) Patent Application Publication
(10) Pub. No.: US 2006/0012687 A1
(43) Pub. Date: Jan. 19, 2006

(54) Format processing apparatus and format processing method

(75) Inventor: Akira Toba, Osaka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: SANYO ELECTRIC CO., LTD, Moriguchi-shi (JP)

(21) Appl. No.: 11/176,241

(22) Filed: Jul. 8, 2005

(30) Foreign Application Priority Data
Jul. 15, 2004 (JP) 2004-208439

(51) Int. Cl. H04N 5/228

(52) U.S. Cl. 348/222.1

(57) ABSTRACT

A format processing apparatus includes a CPU. The CPU determines whether or not a capacity of a recording medium is below a capacity threshold value, and if a result of the capacity determination is affirmative, it is further determined whether or not a degree of fragmentation of information recorded on recording medium is above a degree threshold value. Then, according to a result of the degree determination, any one of a first format process including initialization of the recording medium and a second format process not including initialization of the recording medium is executed.

### BACKGROUND OF THE INVENTION

1. Field of the Invention

The present invention relates to a format processing apparatus and a method thereof.

2. Description of the Prior Art

Conventionally, in recording devices, recording mediums (memory card, hard disk, floppy disk, optical magnetic disk, etc.) are made available by being divided into small parts to reserve areas for managing what is recorded in which area. This operation is a format process, and the recording medium is always formatted before use. Also, the format process is also performed on a recording medium that has already been used. In general, the format process includes a physical format process and a logical format process of two kinds.

When the physical format process is performed on the recording medium, all of the data recorded in the recording area are erased. This prevents file creation, so that initialization of FAT (File Allocation Table) for managing a logical arrangement in the file recording area is performed. As described above, when the physical format process is performed, an erasing process of all the data of the recording area is performed, and then, the FAT is initialized.

When the logical format is performed on the recording medium, only the FAT area for managing a logical arrangement of the files in the file recording area is initialized. By merely performing the initialization on the file management information section of the recording area, faster format processing than in the physical format process can be done.

When the logical format process is performed on the recording medium that has been used, not that all the data in the recording area is erased like the physical format process, but regarding that each block of the recording area is available, writing is performed after confirming that the data of the each block has been erased. On the contrary thereto, when the physical format process is performed, at a time of writing information in the recording medium, because of knowing that each block of the data is available in advance, the need of the confirming operation is eliminated, capable of enhancing the writing speed.

For example, the format process is performed on the recording mediums utilized for an electronic camera, etc. in order to initialize the recording medium before reading and writing.

In a case of recording a file of motion image in the recording medium, the electronic camera has an internal memory such as an SDRAM, etc. as a buffer to be utilized for temporarily retaining the data to be recorded in the recording medium. In a low writing speed to the recording medium, the data to be recorded is retained up to the capacity of the buffer, but excessive data to be retained over the buffer capacity has no other choice than stopping the writing process. Accordingly, the lower the writing speed to the recording medium is, the shorter the successive recordable time period is. Generally, in a file system, several blocks are managed as one unit. In writing the file, a necessary number of blocks out of available blocks are assigned in writing. The blocks utilized at this time is not necessarily successive. It is common that managing the recording medium with a block unit enables the capacity of the recording medium to be effectively used. However, in such a file system, repetitive file writing and erasure make the files (or available blocks) to be recorded in the recording medium great distributed. Thus, a state that files basically being successive information are distributed in the recording medium is called as fragmentation. For example, in a case of highly distributed state, it is said that fragmentation of the recording medium is large.

In a case of recording on a recording medium to which fragmentation highly occurs, an available block is retrieved, and writing of data is performed thereto. This makes the writing speed low. Thus, the capacity of the buffer tends to become full and to shorten a successive recordable time period. Thus, performing the physical format process on the recording medium in such a state resolves the fragmentation, which makes the writing speed faster than that in performing the logical format process, and makes the successive recordable time period longer.

However, as conversion to high-capacity recording medium is advanced in recent years, a time period taken for the physical format process tends to be increased.

One example of a format apparatus of the recording medium for solving the above-described problems is disclosed in Japanese Patent Laying-open No. 8-161121 of “Format Processing Apparatus of Recording Medium”. In the prior art, it is determined whether or not the physical format has already been performed. Then, the physical format is performed on a recording medium that is not subjected to the physical format, and the physical format is performed on a recording medium that has already been subjected to the physical format only when a usage rate of an alternate area exceeds a threshold value. This enables speed-up of the format time period and improvement of reliability of the recording medium.

However, in the prior art, there was a case of taking time to write to the recording medium.

### SUMMARY OF THE INVENTION

Therefore, it is a primary object of the present invention to provide a novel format processing apparatus and format processing method.

Another object of the present invention is to provide a format processing apparatus and a format processing method that are able to shorten a time period required for formatting, and enhance a writing speed to a recording medium that has been formatted.

A format processing apparatus according to the invention of claim 1, comprises: a first capacity determiner (S5) for determining whether or not a capacity of a recording medium (70) is below a first capacity threshold value; a degree determiner (S9) for determining whether or not a degree of fragmentation of the information recorded in the recording medium is above a degree threshold value when the determination result of the first capacity determiner is affirmative; and an executor (S17, S19) for executing any one of a first format process including initialization of the recording medium and a second format process not including initialization of the recording medium in association with the detection result of the degree determiner.

Whether or not the capacity of the recording medium is below the first capacity threshold value is determined by the first capacity determiner. The degree determiner, when the determination result of the first capacity determiner is affirmative, determines whether or not the degree of fragmentation of the information recorded in the recording medium is above the degree threshold value. The executor executes any one of the first format process and the second format process in association with the detection result of the degree determiner. Here, the first format process includes the initialization of the recording medium, and the second format process does not include the initialization of the recording medium.

When the degree of fragmentation of the information recorded in the recording medium is above the degree threshold value, the first format process is executed, which enhances a writing speed to the recording medium. When the degree of fragmentation of the information recorded in the recording medium is not above the degree threshold value, the second format process is executed, which shortens a time period required for formatting the recording medium. The determination of the degree of fragmentation is performed only when the capacity of the recording medium is below the first capacity threshold value, and therefore, it is possible to avoid losing an advantage of shortening the format time period due to excessive time period of detecting the degree of fragmentation.

A format processing apparatus according to the invention of claim 2 is dependent on claim 1, wherein each of the first format process and the second format process includes initialization of a management table on which management information for managing the information recorded in the recording medium is registered.

When the first format process is executed, the recording medium and the management table are initialized. When the second format process is executed, only the management table is initialized.

A format processing apparatus according to the invention of claim 3 is dependent on claim 2, wherein the degree determiner performs a determination on the basis of a degree of fragmentation of the management information registered in the management table.

As the degree of fragmentation of the management information registered in the management table is large, the degree of the fragmentation of the information recorded in the recording medium is also large. Taking the management information in the management table as an object to be checked shortens a time period required for detecting the degree of fragmentation.

A format processing apparatus according to the invention of claim 4 is dependent on claim 1. This further comprises: a highlighter (S13) for displaying in a highlighted manner a first option and a second option respectively corresponding to the first format process and the second format process such that the first option is more highlighted than the second option when the determination result of the degree determiner is affirmative; and an acceptor (S14) for accepting a selecting operation of selecting any one of the first option and the second option displayed by the highlighter, wherein the executor executes the format processing selected by the selecting operation.

The highlighter displays, when the determination result of the degree determiner is affirmative, the first option and the second option respectively corresponding to the first format process and the second format process such that the first option is more highlighted than the second option. The selecting operation of selecting any one of the first option and the second option thus displayed is accepted by the acceptor, and the executor executes the format processing selected by the selecting operation.

Since the first option and the second option respectively corresponding to the first format process and the second format process are displayed, the selecting operation of selecting any one of the displayed first option and the second option is accepted, and therefore, it is possible for the user to arbitrary select which is to be taken precedence, shortening the format time period and speeding up of writing. When the determination result of the degree determiner is affirmative, the first option is highlighted, which allows the operator to precisely perform the selecting operation.

A format processing apparatus according to the invention of claim 5 is dependent on claim 4. This further comprises: an invalidator (S3) for invalidating the degree determiner when the capacity of the recording medium is below a second capacity threshold value being smaller than the first capacity threshold value, wherein the highlighter performs a display in response to the invalid of the invalidator.

The invalidator invalidates the degree determiner when the capacity of the recording medium is below the second capacity threshold value being smaller than the first capacity threshold value. The highlighter performs the display in response to the invalid of the invalidator.

If the capacity of the recording medium is below the second capacity threshold value (<first capacity threshold value), there is little difference between a time period required for the first format process and a time period required for the second format process, and determination of the degree is omitted to directly highlight the first option, capable of reducing a processing load and improving operability.

A format processing apparatus according to the invention of claim 6 is dependent on claim 5, wherein the highlighting includes at least any one of blinking, boldfacing, zooming, coloring, and addition of a character.

A format processing method according to the invention of claim 7, comprises: a first capacity determining step (S5) for determining whether or not a capacity of a recording medium (70) is below a first capacity threshold value; a degree determining step (S9) for determining whether or not a degree of fragmentation of the information recorded in the recording medium is above a degree threshold value when the determination result of the first capacity determining step is affirmative; and an executing step (S17,S19) for executing any one of a first format process including initialization of the recording medium and a second format process not including initialization of the recording medium in association with the detection result of the degree determining step

A format processing method according to the invention of claim 8 is dependent on claim 7, wherein each of the first format process and the second format process includes initialization of a management table on which management information for managing the information recorded in the recording medium is registered.

A format processing method according to the invention of claim 9 is dependent on claim 8, wherein the degree determining step performs a determination on the basis of a degree of fragmentation of the management information registered in the management table.

A format processing method according to the invention of claim 10 is dependent on claim 7. This further comprises: a highlighting step (S13) for displaying in a highlighted manner a first option and a second option respectively corresponding to the first format process and the second format process such that the first option is more highlighted than the second option when the determination result of the degree determining step is affirmative; and an accepting step (S14) for accepting a selecting operation for selecting any one of the first option and the second option displayed by the highlighting step, wherein the executing step executes the format processing selected by the selecting operation.

A format processing method according to the invention of claim 11 is dependent on claim 10. This further comprises an invalidating step (3) for invalidating the degree determining step when the capacity of the recording medium is below a second capacity threshold value being smaller than the first capacity threshold value, wherein the highlighting step performs a display in response to the invalid of the invalidating step.

A format processing method according to the invention of claim 12 is dependent on claim 11, wherein the highlighting includes at least any one of blinking, boldfacing, zooming, coloring, and addition of a character.

According to the present invention, it is possible to shorten a time period required for formatting, enhancing a writing speed to the formatted recording medium.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 (a) is a front view showing an electronic camera of one embodiment of the present invention;

FIG. 1 (b) is a rear view showing the electronic camera of FIG. 1 (a) embodiment 1;

FIG. 2 is a block diagram showing a configuration of FIG. 1 (a) embodiment;

FIG. 3 is a flowchart showing a part of operation of FIG. 1 (a) embodiment;

FIG. 4 (a) is an illustrative view showing one example of a format process selecting screen applied to FIG. 1 (a) embodiment;

FIG. 4 (b) is an illustrative view showing another example of the format process selecting screen applied to FIG. 1 (a) embodiment;

FIG. 4 (c) is an illustrative view showing the other example of the format process selecting screen applied to FIG. 1 (a) embodiment;

FIG. 4 (d) is an illustrative view showing a further example of the format process selecting screen applied to FIG. 1 (a) embodiment;

FIG. 4 (e) is an illustrative view showing another example of the format process selecting screen applied to FIG. 1 (a) embodiment; and

FIG. 5 is a flowchart showing a part of operation of another embodiment of the present invention.

### DETAILED DESCRIPTION OF THE PREFERRED EMBODIMENTS

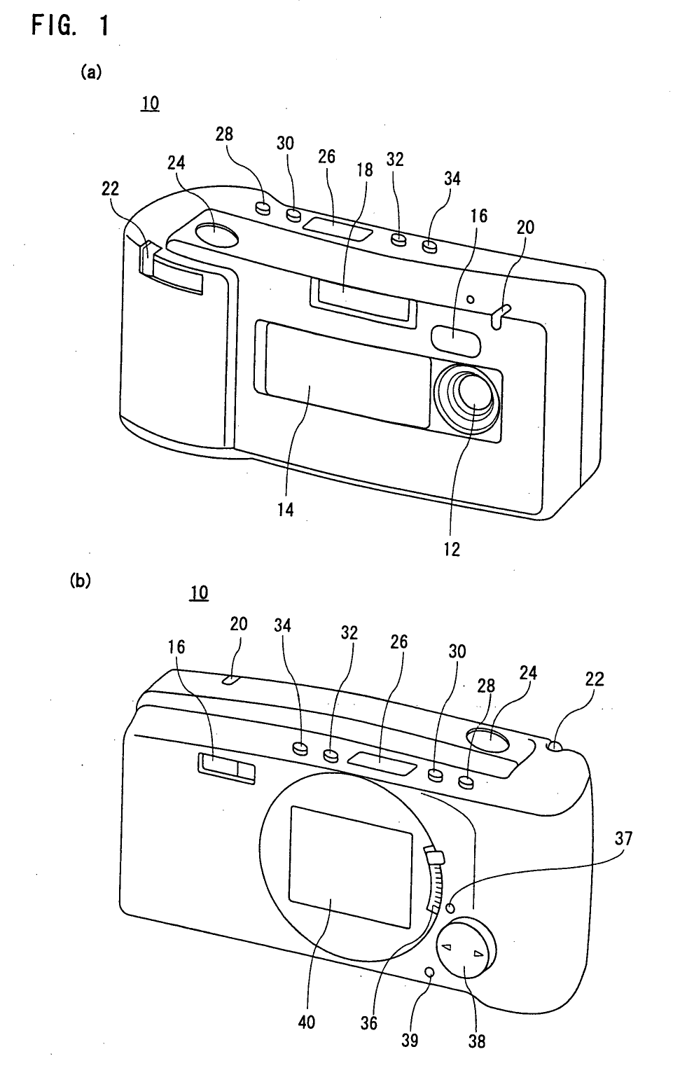

Referring to FIG. 1 (a) and FIG. 1 (b), an electronic camera 10 of this embodiment of the present invention is provided with a lens 12, a lens cover 14, a finder 16, a flash light-emission portion 18 and a self-timer lamp 20 on a front surface, and is provided with a monitor switch 22 at a grip portion on its front surface. Furthermore, a shutter button 24, a control panel 26, and various buttons 28-34 are provided on an upper portion of the electronic camera. A reproduction switch 36, a menu key 37, and a liquid crystal display 40 are provided on a rear surface. Photographing available numbers, a battery power, etc. are displayed on the control panel 26.

A cursor button 38 is for sending and returning a screen to be displayed on the liquid crystal display 40, and selecting respective menus. The menu key 37 is for calling a menu, and a determination key 39 is for determining each of the selected menus.

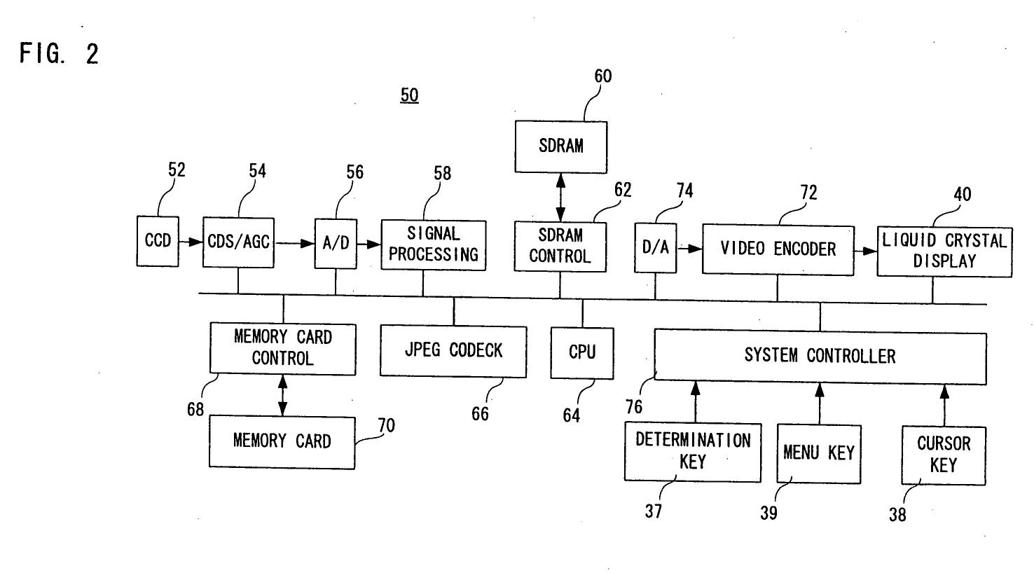

FIG. 2 shows a block diagram 50 of the electronic camera 10 of one embodiment of the present invention.

When an imaging operation is performed by the shutter button 24, a CPU 64 applies a control signal to a CCD 52, a CDS (Correlated Double Sampling)/AGC (Aout Gain Controll) circuit 54, an A/D circuit 56, a signal processing circuit 58, a JPEG (Joint Photographics Experts Group) codec circuit 66, an SDRAM control circuit 62, and a memory card control circuit 68. The CCD 52 converts a light incident through a lens 12 into an analog electric signal. The CDS/AGC circuit 54 performs a sampling, noise removal of low frequencies, and gain adjustment on the output signal from the CCD 52 to generate an analog imaging signal. The A/D circuit 56 converts the analog imaging signal generated in the CDS/AGC circuit 54 into digital imaging data. The signal processing circuit 58 generates three color signals of R, G, B on the basis of the digital imaging data generated in the A/D circuit 56, and performs a processing for converting these signals into a luminance signal or Y signal, and two color difference signals of U and V. The digital image data of Y, U, V signals thus obtained are temporarily stored in an SDRAM 60, and then, the digital image data are compressed by the JPEG codec circuit 66 in a JPEG format. The compressed digital compression data is temporarily stored in the SDRAM 60 as a memory buffer by the SDRAM control circuit 62, and the digital compression data temporarily stored is recorded in a memory card 70 by the memory card control circuit 68.

By turning the reproduction switch 36 on, a recorded image is reproduced. A system controller 76 applies a read control signal to the memory card control circuit 68 to read the digital compression data recorded in the memory card 70 through the SDRAM control circuit 62 to the SDRAM 60, and expands the compressed digital compression data by the JPEG codec circuit 66. Then, the digital image data is converted into an analog imaging signal by a D/A circuit 74, and the analog signal is converted in to an NTSC signal by a video encoder 72, and whereby, an image is displayed on the liquid crystal display 40. When the user performs a screen sending or screen returning operation by depressing the cursor key 38, and reading of the image data corresponding thereto is performed.

This embodiment takes an SD memory card that has heavily been used into account. An NAND flash integrated in the SD memory card is characterized by being readable in a sector unit, writable in a physical block size unit forming of a plurality of sectors, and erasable in a physical block size unit. In general, flash memories are unwritable without erasure being performed in advance. Memory cards such as an SD memory card, a compact flash (registered trademark), in which a controller is integrated, allow the controller to perform erasure before writing. However, writing is finished faster in a memory card on which a physical format process has been performed than a memory card on which a logical format process is performed because erasure has already been done on the memory card on which the physical format process has been performed.

By depressing the menu key 39, a menu screen is displayed on the liquid crystal display 40. When a format processing menu of the memory card 70 is selected from the menu screen by the cursor key 38, and determined by the determination key 37, the CPU 64 applies a control signal to the memory card control circuit 68.

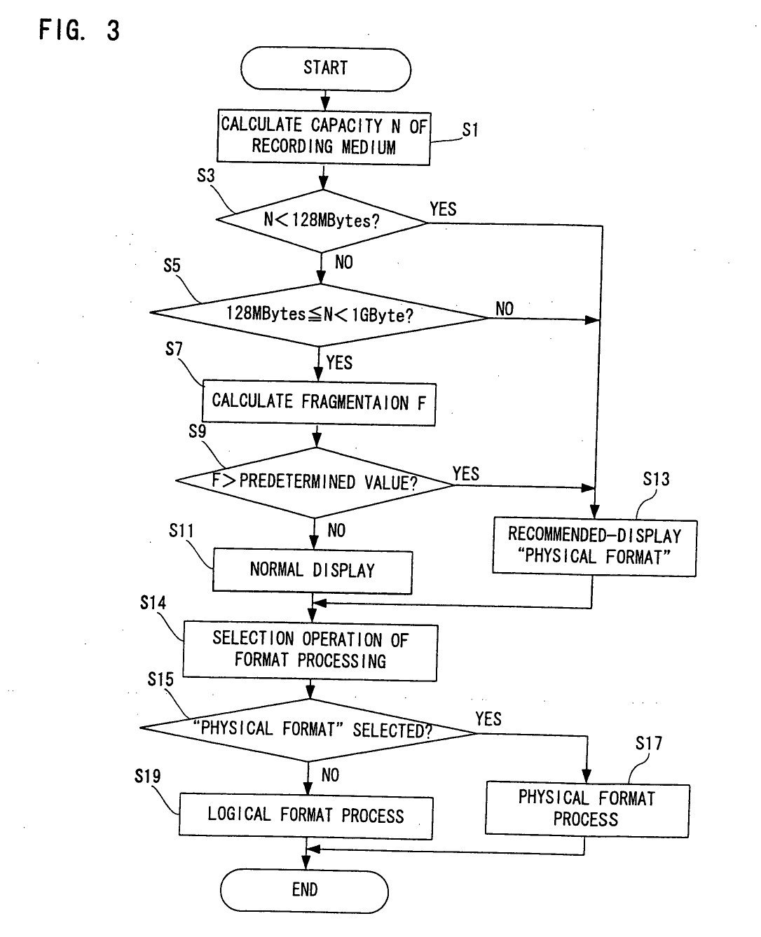

Referring to FIG. 3, a series of format processing is described. In a step S1, the CPU 64 applies a control signal to the memory card control circuit 68 to calculate a capacity N of the memory card 70 as a recording medium. In a step S3, it is determined whether or not the capacity N of the memory card 70 calculated in the step S1 is less than 128 MBytes. The SD memory cards currently come in 32-MByte, 64-MByte, 128-MByte, 256-MByte, 512-MByte, 1-GByte capacities, and realize high-speed data transmission up to 10 MB/sec. It is noted that the data transmission rate of 10 MB/sec is a logical value, and varied depending on use conditions and appliances to be used. Currently, the SD memory card realizing high-speed data transmission comes in equal to or more than 256-MB capacity. At a time of recording a motion image, the SD memory card of 128 MBytes is a limit of capacity capable of recording motion images up to full card capacity when writing is performed on the basis of the working capacity of the SDRAM, and thus, the 128-Mbyte capacity is used as an example of the threshold value of the capacity.

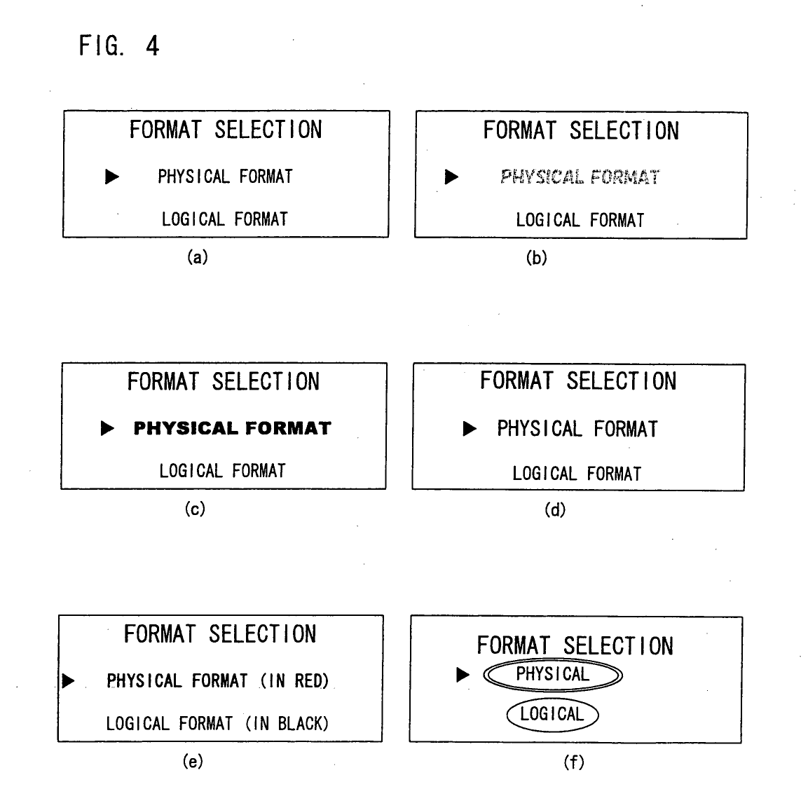

If “YES” in the step S3, the process proceeds to a step S13 to cause the CPU 64 to display on the liquid crystal display 40 the format process selecting screen-including a “logical format” and a blinked “physical format” as shown in FIG. 4 (b). Thus, implying that the physical format process is more recommended than the logical format process, the “physical format” is recommended-displayed in a blinking manner to make it easy to understand that it is more recommended than the “logical format”. In performing the format processing, if the capacity N of the memory card 70 as a recording medium is less than 128 MBytes to take less time to perform the physical format process, the physical format process is recommended to the user, and the process proceeds to a step S15. If “NO”, the process proceeds to a step S5.

In the step S5, the CPU 64 determines whether or not the capacity N of the memory card 70 as a recording medium is more than 128 MBytes and less than 1 GByte. If “YES” is determined, a fragmentation F of an area of the memory card 70 as a recording medium is calculated in a step S7. The CPU 64 evaluates the fragmentation F by counting the number of fragments for each file in the FAT area of the memory card 70 as a recording medium. If “NO”, that is, if it is equal to or more than 1 GByte, the process proceeds to the step S13 to allow the CPU 64 to display on the liquid crystal display 40 the format process selecting screen including the “logical format” and the blinked “physical format”. Thus, implying that the physical format process is more recommended than the logical format process, the “physical format” is recommended-displayed in a blinking manner to make it easy to understand that it is more recommended than the “logical format”. That is, the checking of the fragmentation F is not performed since the capacity N of the memory card 70 as a recording medium has so large a capacity that it takes a time to perform the calculating process of the fragmentation F. A little fragmentation may decrease a sequential recordable time period to the memory card 70 as a recording medium due to the largeness of the capacity. Therefore, the physical format process is recommended to the user.

In a step S9, the CPU 64 determines whether or not the fragmentation F of the memory card 70 as a recording medium is large. If the fragmentation F calculated in the step S7 is above a predetermined value, that is, if “YES”, it is determined that the fragmentation F is large. The predetermined value of the fragmentation F is set to a value to such a degree that a writing speed is not so low at a time of writing the digital compression data from the SDRAM 60 to the memory card 70 as a recording medium. Then, the process proceeds to the step S13 to display on the liquid crystal display 40 the format process selecting screen including the “logical format” and the blinked “physical format” as shown in FIG. 4 (b). Thus, implying that the physical format process is more recommended than the logical format process, the “physical format” is recommended-displayed in a blinking manner to make it easy to understand that it is more recommended than the “logical format”. If the physical format process is not performed in a large fragmentation, the writing speed may be low, and a successive recordable time period to the memory card 70 as a recording medium may be short, and therefore, the physical format process is more recommended to the user. If “NO” in the step S9, the process proceeds to a step S11 to allow the CPU 64 to display on the liquid crystal display 40 the format process selecting screen including a “logical format” and a blinked “physical format” as shown in FIG. 4 (a). In this case, no recommendable format processing is present, and therefore, a display for being especially recommended to the user is not performed. If the fragmentation F is less than the predetermined value, that is, if the fragmentation is small, there is no need to select between the physical format process and the logical format process, capable of selecting a format processing at user's discretion.

In a step S14, a selection operation of the format processing is performed, selecting any one of the “logical format” and the “physical format” from the format process selecting screen including the “logical format” and the “physical format” displayed on the liquid crystal display 40 with the use of the cursor key 38 by the user, and determining it with the use of the determination key 37. Then, the process proceeds to a step S15.

In the step S15, the CPU 64 determines whether or not the kind of the format processing selected in the step 14 is the “physical format”. If “YES” here, that is, if the kind of the selected format processing is the “physical format”, the process proceeds to a step S17 to perform the physical format process on the memory card 70 as a recording medium. If “NO”, that is, if the kind of the selected format processing is the “logical format”, the process proceeds to the step S19 to perform the logical format process on the memory card 70 as a recording medium.

Accordingly, the kind of the format processing is recommended-displayed with respect to the user depending on a capacity of the recording medium and the degree of the fragmentation, and this allows the user to perform the kind of the selected format processing, capable of improving operability.

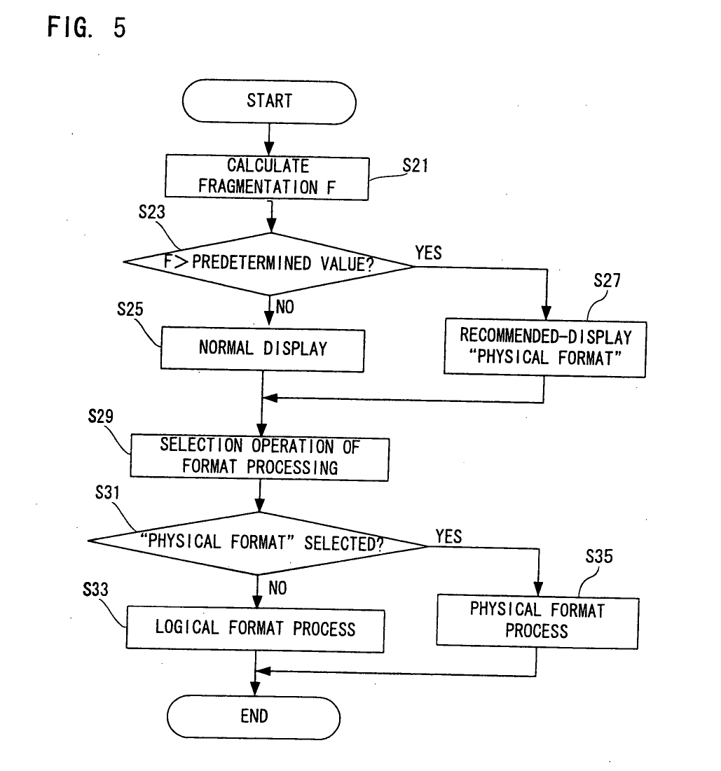

A series of format processing is described above, and next, a series of format processing of another embodiment will be described referring to FIG. 5. It is noted that a configuration of the electronic camera 10 of another embodiment is equal to that in the above-described embodiment (FIG. 1 (a), (b) and FIG. 2), and the difference between the two embodiments is only the format processing operation. In the format processing operation also, the steps illustrated in FIG. 5 are similar to the steps S7 to S19 illustrated in FIG. 3 of the above-described embodiment.

As shown in FIG. 5, in a step S21, the fragmentation F of the area of the memory card 70 as a recording medium is calculated.

In a step S23, it is determined whether or not the fragmentation F of the Memory card 70 as a recording medium is large. If the fragmentation F calculated in the step S21 is above the predetermined value, that is, if “YES”, it is determined that the fragmentation is large. Then, the process proceeds to a step S27 to display on the liquid crystal display 40 the format process selecting screen including the “logical format” and the blinked “physical format” as shown in FIG. 4 (b). If “NO”, the process proceeds to a step S25 to allow the CPU 64 to display the format process selecting screen including the “logical format” and the “physical format” on the liquid crystal display 40 as shown in FIG. 4(a).

In a step S29, a selection operation of the format processing is performed, selecting any one of the “logical format” and the “physical format” from the format process selecting screen including the “logical format” and the “physical format” displayed on the liquid crystal display 40 with the use of the cursor key 38 by the user, and determining it with the use of the determination key 37. Then, the process proceeds to a step S31.

In the step S31, the CPU 64 determines whether or not the kind of the format processing selected in the step S29 is the “physical format”. If “YES”, that is, if the kind of the selected format processing is the “physical format”, the process proceeds to a step S35 to perform the physical format process on the memory card 70 as a recording medium. If “NO”, that is, if the kind of the selected format processing is the “logical format”, the process proceeds to a step S33 to perform the logical format process on the memory card 70 as a recording medium.

Accordingly, the kind of the format processing is recommended-displayed with respect to the user depending on the degree of fragmentation, and this allows the user to perform the kind of the selected format processing, capable of improving operability.

It is noted that although the “physical format” is displayed in a blinking manner at a time of recommended-displaying the “physical format” in the embodiments of the present invention, displays shown in FIG. 4 (c)-FIG. 4 (e) may be possible. FIG. 4 (c) displays the kind of recommendable format processing in boldface type, FIG. 4 (d) displays the kind of recommendable format processing in a zoomed manner, and FIG. 4 (e) displays the kind of recommendable format processing in a vivid color. Furthermore, as shown in FIG. 4 (f), the “physical format” and the “logical format” are distinguished from each other by symbols on the format process selecting screen.

In addition, in the embodiments of the present invention, the fragmentation F is calculated by counting the number of fragments for each file in the FAT area of the memory card 70. However, another method of calculating the fragmentation F, the fragmentation F may be calculated by comparing distances between the respective fragments and a predetermined value, or by counting the number of the files each having a fragmentation.

Furthermore, although the CCD 52 is employed as an imaging device of the electronic camera 10 in the embodiments of the present invention, a CMOS sensor may be used.

In the embodiments of the present invention, the digital image data of Y, U, V signals are compressed in a JPEG format by the JPEG codec circuit 66. However, it may be compressed in a JPEG-2K (Joint Photograpics Experts Group 2000) format, an M-JPEG (Motion JPEG) format, or an MPEG (Moving Picture Experts Group) format.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A format processing apparatus, comprising:
a first capacity determiner for determining whether or not a capacity of a recording medium is below a first capacity threshold value;
a degree determiner for determining whether or not a degree of fragmentation of said information recorded in said recording medium is above a degree threshold value when the determination result of said first capacity determiner is affirmative; and
an executor for executing any one of a first format process including an initialization of said recording medium and a second format process not including initialization of said recording medium in association with the detection result of said degree determiner.

2. A format processing apparatus according to claim 1, wherein each of said first format process and said second format process includes initialization of an management table on which management information for managing the information recorded in said recording medium is registered.

3. A format processing apparatus according to claim 2, wherein said degree determiner performs a determination on the basis of a degree of fragmentation of the management information registered in said management table.

4. A format processing apparatus according to claim 1, further comprising:
a highlighter for displaying in a highlighted manner a first option and a second option respectively corresponding to said first format process and said second format process such that said first option is more highlighted than said second option when the determination result of said degree determiner is affirmative; and
an acceptor for accepting a selecting operation for selecting any one of said first option and said second option displayed by said highlighter, wherein
said executor executes the format processing selected by said selecting operation.

5. A format processing apparatus according to claim 4, further comprising: an invalidator for invalidating said degree determiner when the capacity of said recording medium is below a second capacity threshold value being smaller than said first capacity threshold value, wherein said highlighter performs a display in response to the invalid of said invalidator.

6. A format processing apparatus according to claim 5, wherein said highlighting includes at least any one of blinking, boldfacing, zooming, coloring, and addition of a character.

7. A format processing method, comprising:
a first capacity determining step for determining whether or not a capacity of a recording medium is below a first capacity threshold value;
a degree determining step for determining whether or not a degree of fragmentation of the information recorded in said recording medium is above a degree threshold value when the determination result of said first capacity determining step is affirmative; and
an executing step for executing any one of a first format process including initialization of said recording medium and a second format-process not including initialization of said recording medium in association with the detection result of said degree determining step.

8. A format processing method according to claim 7, wherein said each of said first format process and said second format process includes initialization of an management table on which management information for managing the information recorded in said recording medium is registered.

9. A format processing method according to claim 8, wherein said degree determining step performs a determination on the basis of a degree of fragmentation of the management information registered in said management table.

10. A format processing method according to claim 7, further comprising:
a highlighting step for displaying in a highlighted manner a first option and a second option respectively corresponding to said first format process and said second format process such that said first option is more highlighted than said second option when the determination result of said degree determining step is affirmative; and
an accepting step for accepting a selecting operation for selecting any one of said first option and said second option displayed by said highlighting step, wherein
said executing step executes the format processing selected by said selecting operation.

11. A format processing method according to claim 10, further comprising an invalidating step for invalidating said degree determining step when the capacity of said recording medium is below a second capacity threshold value being smaller than said first capacity threshold value, wherein said highlighting step performs a display in response to the invalid of said invalidating step.

12. A format processing method according to claim 11, wherein said highlighting includes at least any one of blinking, boldfacing, zooming, coloring, and addition of a character.
